(19) United States
(12) Patent Application Publication
(10) Pub. No.: US 2025/0162076 A1
(43) Pub. Date: May 22, 2025

(54) Laser Welding Method, Terminal Joint Structure, and Power Conversion Device

(71) Applicant: Hitachi Astemo, Ltd., Hitachinaka-shi, Ibaraki (JP)

(72) Inventors: Hiroshi SHIRATORI, Tokyo (JP); Masanori MIYAGI, Tokyo (JP); Takuro KANAZAWA, Hitachinaka-shi (JP); Fusanori NISHIKIMI, Hitachinaka-shi (JP); Toru KATO, Hitachinaka-shi (JP); Takahiro MORI, Hitachinaka-shi (JP)

(21) Appl. No.: 18/836,811

(22) PCT Filed: Mar. 23, 2023
(86) PCT No.: PCT/JP2023/011625

§ 371 Date: Aug. 8, 2024

(30) Foreign Application Priority Data
May 18, 2022 (JP) 2022-081839

(51) Int. Cl. B23K 26/244; B23K 26/32; B23K 101/38; B23K 103/10; B23K 103/12

(52) U.S. Cl. CPC B23K 26/244; B23K 26/32; B23K 2101/38; B23K 2103/10; B23K 2103/12

(57) ABSTRACT

This laser welding method involves superposing a first terminal and a second terminal which are composed of a metal material containing copper and aluminum as a main component, and welding and joining the first terminal and the second terminal with a laser, the method including a laser irradiation step for irradiating, with a laser, along the edge of the first terminal, each of a first upper surface which is the opposite surface to a surface of the first terminal superposed on the second terminal, and a second upper surface which is the surface on the same side, of the second terminal superposed on the first terminal, wherein in the laser irradiation step, laser is emitted a plurality of times under the conditions for heat transfer mode welding.

### TECHNICAL FIELD

The present invention relates to a laser welding method, a terminal joint structure, and a power conversion device.

### BACKGROUND ART

In a power conversion device, an engine control unit, a motor, a battery, and the like, a conductor called a bus bar is used to obtain electrical connection. For example, an inverter is a device that generates an alternating current from a direct current power supply such as a battery, and includes a power module including a switching element and the like, a smoothing capacitor, a bus bar, a control circuit, and the like. The bus bar is electrically connected to the power module, the smoothing capacitor, and the like, and the alternating current generated by the power module is supplied to the motor via the bus bar. Since the bus bar is required to have conductivity, copper or aluminum is generally used, and tungsten inert gas (TIG) welding is often used as a connection method.

In the TIG welding, a joint called a butt joint is often employed in which bus bars are erected and butted to each other. However, the butt joint has a low space efficiency for erecting the bus bars, and is a welded joint disadvantageous for miniaturization and space saving. Thus, it has been studied to weld the bus bars using a lap joint. The lap joint is a method in which the bus bars vertically overlap with each other and joined to each other, and is a welded joint having an excellent space efficiency. In the case of the lap joint, laser welding with a high energy efficiency is generally used. A melting mode of the laser welding is roughly divided into a keyhole mode and a thermal conduction mode. In many cases, keyhole mode welding in which deep penetration is obtained is adopted, but on the other hand, splash of molten metal called sputtering occurs in the keyhole mode welding. The sputtering adheres to the periphery of a welded portion and causes defects such as short circuit. Thermal conduction mode welding is a melting mode in which the sputtering does not occur, but has the disadvantage of shallow penetration having a penetration depth from 0.2 mm to 0.3 mm. Since s plate thickness of the bus bar is often 0.3 mm or more, and a thick bus bar has a thickness from about 0.5 mm to about 1.5 mm, it is difficult to weld a first terminal and a second terminal in the thermal conduction mode welding.

Patent Literature 1 discloses a method for welding, by laser, an object to be machined, the method including steps of disposing the object to be machined in a region irradiated with a laser beam from a laser device, relatively moving the laser beam and the object to be machined while irradiating the object to be machined with the laser beam from the laser device; and melting and welding the object to be machined in an irradiated portion while sweeping the laser beam on the object to be machined, in which the laser beam includes a main beam and a sub-beam at least a part of the sub-beam is ahead in a sweep direction, and a power density of the main beam is equal to or higher than a power density of the sub-beam.

### CITATION LIST

### Patent Literature

PTL 1: WO 2018/159857 A

### SUMMARY OF INVENTION

### Technical Problem

In the invention described in Patent Document 1, there is room for improvement in suppression of sputtering.

### Solution to Problem

A laser welding method according to a first aspect of the present invention is a laser welding method of overlapping a first terminal and a second terminal made of a metal material containing copper or aluminum as a main component with each other, and melt joining the first terminal and the second terminal by laser, the laser welding method including: a laser irradiation step of irradiating each of a first upper surface that is an opposite surface to a surface of the first terminal overlapped with the second terminal and a second upper surface that is a surface on the same side as a surface of the second terminal overlapped with the first terminal with the laser along an edge of the first terminal, in which in the laser irradiation step, the laser irradiation is performed a plurality of times under a condition of thermal conduction mode welding.

A terminal joint structure according to a second aspect of the present invention is a terminal joint structure including: a welded portion in which a first terminal and a second terminal made of a metal material containing copper or aluminum as a main component are overlapped with each other and an overlapped portion is melt-joined by laser, in which the welded portion includes a first region in which columnar crystal grains extend toward a region along an edge of the first terminal on an upper surface of the first terminal that is an opposite surface to an overlapped surface between the first terminal and the second terminal, and a second region in which columnar crystal grains extend toward a region along the edge of the first terminal on an upper surface of the second terminal that is a surface on the same side as the overlapped surface.

A power conversion device according to a third aspect of the present invention has the above-described terminal joint structure.

### Advantageous Effects of Invention

According to the present invention, sputtering in the laser welding can be suppressed.

### BRIEF DESCRIPTION OF DRAWINGS

FIG. 1 is a side view of a power conversion device.

FIG. 2 is a schematic view illustrating a welding method between a first terminal and a second terminal.

FIG. 3 is a schematic view of a welding device.

FIG. 4 is a cross-sectional view of a welding position.

FIG. 5 is a cross-sectional view of a welding position in a comparative example.

FIG. 6 is a view illustrating irradiation with a laser beam in Example 2.

FIG. 7 is a view illustrating a welding method in Modification 1.

FIG. 8 is a view for describing an effect of Modification 1.

FIG. 9 is a view illustrating shapes of a first terminal in Modification 2.

### DESCRIPTION OF EMBODIMENTS

### Embodiments

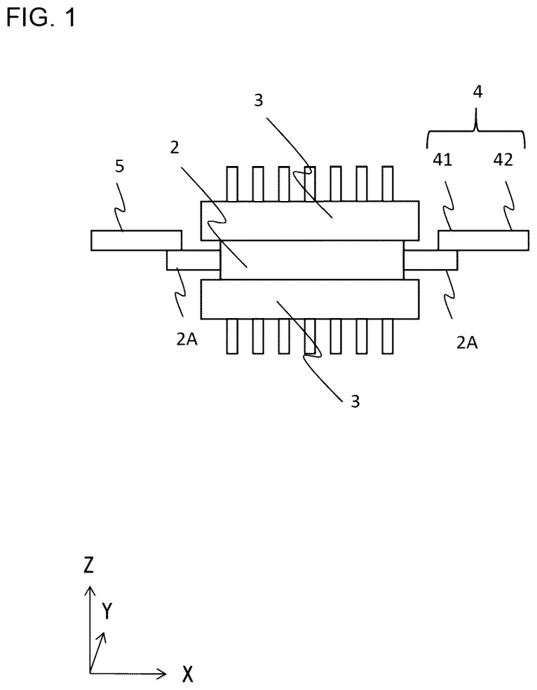

Hereinafter, embodiments of a power conversion device and a welding method according to the present invention will be described with reference to FIGS. 1 to 6.

### Configuration

FIG. 1 is a side view of a power conversion device 1 according to the present invention. In FIG. 1, mutually orthogonal X-axis, Y-axis, and Z-axis are illustrated for convenience of description. The power conversion device 1 includes a semiconductor element 2, a plurality of heat dissipation plates 3, a terminal block 4, and a capacitor 5. The semiconductor element 2 includes a plurality of connection terminals 2A. The terminal block 4 includes a semiconductor-side end portion 41 and an external-side end portion 42. The heat dissipation plates 3 sandwiches the semiconductor element 2 from both sides, that is, from a plus side and a minus side, respectively, of the Z-axis. The heat dissipation plate 3 includes fins illustrated as protrusions in a side view, and enables efficient heat dissipation.

The semiconductor-side end portion 41 overlaps the connection terminal 2A of the semiconductor element 2 in a Z direction, and is welded to the connection terminal 2A at the overlapped portion by a method described later. The external-side end portion 42 is connected to the outside of the power conversion device 1. The capacitor 5 overlaps the connection terminal 2A in the Z direction, and s welded to the connection terminal 2A at the overlapped portion by a method described later. The welding method between the semiconductor-side end portion 41 and the connection terminal 2A is the same as the welding method between the capacitor 5 and the connection terminal 2A. Hereinafter, a member to be welded is generically referred to as a “first terminal” and a “second terminal”.

### Welding Method

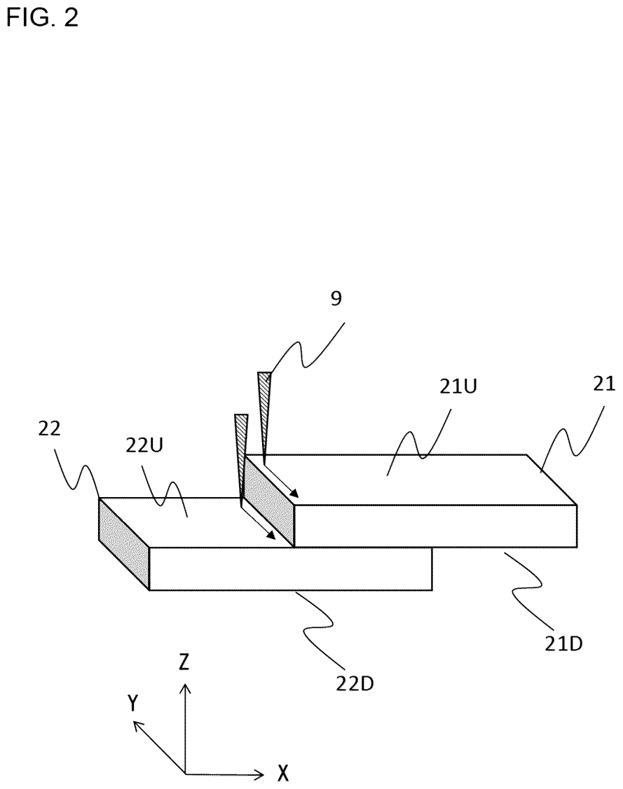

FIG. 2 is a schematic view illustrating a welding method between a first terminal 21 and a second terminal 22. The first terminal 21 and the second terminal 22 are disposed so as to overlap each other in the Z-axis direction. In the example illustrated in FIG. 2, a laser beam 9 is emitted from a Z-axis plus direction. Hereinafter, a surface of the first terminal 21 on a Z-axis plus side is referred to as a first upper surface 21U, and a surface of the first terminal 21 on a Z-axis minus side is referred to as a first lower surface 21D. A surface of the second terminal 22 on the Z-axis plus side is referred to as a second upper surface 22U, and a surface of the second terminal 22 on the Z-axis minus side is referred to as a second lower surface 22D. The first terminal 21 is located on the plus side of the Z-axis, and the second terminal 22 is located on the minus side of the Z-axis. Thus, the first lower surface 21D and the second upper surface 22U overlap with each other. The first upper surface 21U of the first terminal 21 is an opposite surface to the first lower surface 21D overlapped with the second terminal 22. The second upper surface 22U of the second terminal 22 is a surface on the same side as a surface overlapped with the first terminal 21.

The first terminal 21 and the second terminal 22 are made of a highly conductive metal, copper, aluminum, copper, or an aluminum alloy. The first terminal 21 and the second terminal 22 are not limited to a flat plate shape, and may be a prismatic pin or a cylindrical pin. In the present embodiment, the first upper surface 21U and the second upper surface 22U are irradiated with the laser beam 9 a plurality of times under the condition of being in the thermal conduction mode along an edge of the first terminal 21 on an X-axis minus side. When an end portion where heat is likely to be accumulated is irradiated with laser a plurality of times under the condition of the thermal conduction mode, locally preheated state is established, and deep penetration is obtained even in the thermal conduction mode.

When a distance of a laser irradiated position is too close from an end surface, the first terminal 21 is not sufficiently irradiated with the laser, and conversely, when the laser irradiated position is too far from the end surface, it is difficult to join with a second terminal 22 melted portion. Thus, the irradiation with the laser beam 9 is preferably performed at a position from 0.1 mm to 5 mm from the end portion, more preferably at a distance from 0.2 mm to 3 mm, and still more preferably at a distance from 0.3 mm to 1.5 mm. The order of irradiating the first terminal 21 and the second terminal 22 with the laser beam 9 is optional, and either may precede, or in the case of irradiating the first terminal 21 and the second terminal 22 a plurality of times, irradiation may be alternately performed once.

The thermal conduction mode welding is welding characterized by small penetration ratio in which laser incident energy is transmitted to a weld root portion only by thermal conduction and convection in molten metal, and is sometimes referred to as thermal conduction type welding. Welding contrary to the thermal conduction mode welding is keyhole welding, and is a welding method in which a keyhole (hole surrounded by a molten metal formed when irradiated with a laser beam having an energy density high enough to evaporate the material) is formed near a distal end of a molten pool to obtain penetration with a high penetration ratio.

However, the second terminal 22 is not melted and the first terminal 21 and the second terminal 22 are not sufficiently joined to each other only by irradiating the end portion of the first terminal 21 with the laser a plurality of times under the condition of the thermal conduction mode. Thus, the upper surface of the second terminal 22 that is the surface on the same side as the overlapped surface is also irradiated with the laser a plurality of times along the end surface under the condition of the thermal conduction mode. Even in the case where the upper surface of the second terminal 22 is irradiated with the laser, the distance from the end surface needs to be set to be neither too close nor too far, and a position is preferably from 0.1 mm to 5 mm, more preferably at a distance from 0.2 mm to 3 mm, and still more preferably at a distance from 0.3 mm to 1.5 mm. By also irradiating the second terminal 22 with the laser beam 9, the second upper surface 22U, which is the upper surface of the second terminal 22 near the end surface, is melted and connected to the first terminal 21 to be joined.

### Terminal Welding Device

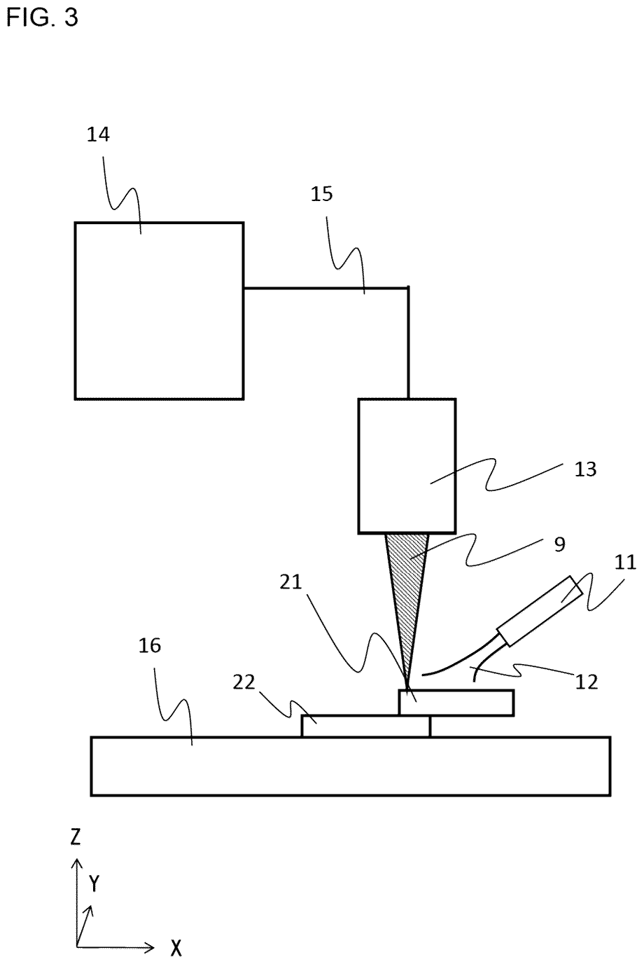

FIG. 3 is a schematic view of a welding device 100 that performs welding described with reference to FIG. 2. The welding device 100 includes a shielding gas nozzle 11 that provides a shielding gas 12, a laser processing head 13 that emits a laser beam 9, a laser oscillator 14 that generates the laser beam 9, an optical fiber 15 that connects the laser oscillator 14 and the laser processing head 13 to each other, and an XY stage 16 that moves an object to be welded.

The wavelength of the laser beam 9 generated by the laser oscillator 14 is not particularly limited, but the wavelength is preferably 600 nm or less, and more preferably 500 nm or less in order to stably perform the thermal conduction mode welding. Specifically, a green laser having a wavelength of 532 μm and a blue laser having a wavelength of 450 μm are preferable. The shielding gas 12 is, for example, argon gas. The welding device 100 irradiates the first terminal 21 and the second terminal 22 through the optical fiber 15 and the laser processing head 13 with the laser generated by the laser oscillator 14. The XY stage 16 is operated during laser irradiation to weld any position. By irradiating the first upper surface 21U and the second upper surface 22U with the laser 10 a plurality of times along the end portion of the first terminal 21, the end portion of the first terminal 21 and the second terminal 22 are melted and mixed to each other to form a joint portion between the first terminal 21 and the second terminal 22.

### Welding Method

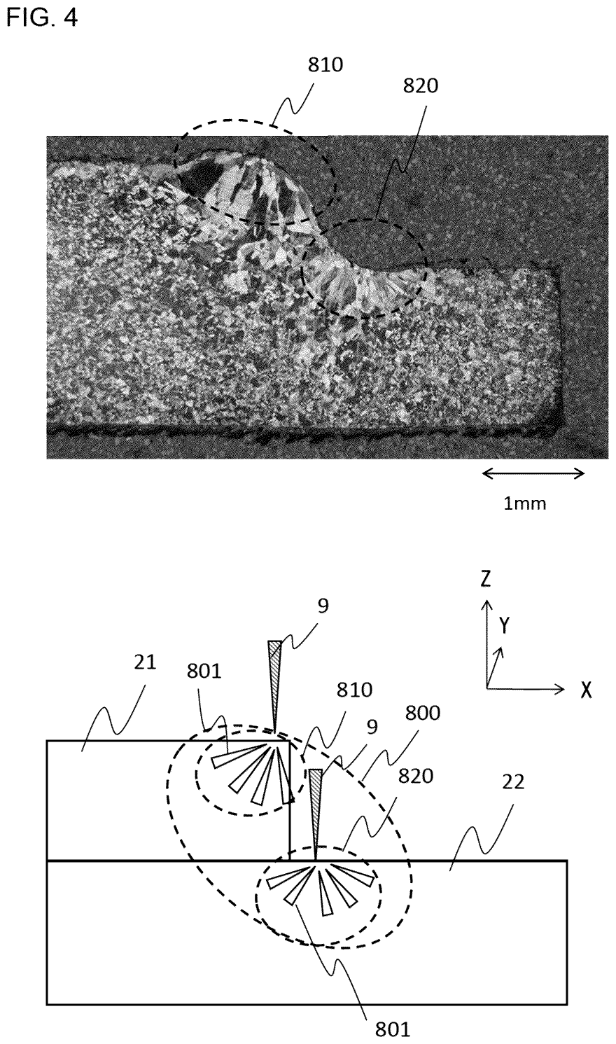

Welding between the first terminal 21 and the second terminal 22 by using the welding device 100 is divided into a laser irradiation step and a welded portion forming step. First, in the laser irradiation step, the first terminal 21 and the second terminal 22 are irradiated with the laser beam 9 by using the welding device 100. In the subsequent welded portion forming step, a region irradiated with the laser beam 9 is gradually cooled to form a welded portion. The welded portion will be described below with reference to FIG. 4. Heat dissipation in the welded portion forming step may be natural heat dissipation, or ambient temperature or air flow may be controlled in order to promote or suppress cooling.

### Cross-Sectional View

FIG. 4 is a cross-sectional view of a welding position. The upper part of FIG. 4 is a cross-sectional photograph, and the lower part of FIG. 4 is a schematic view for describing the cross-sectional photograph. A detailed procedure for obtaining the cross-sectional photograph will be described later. The length of an arrow illustrated in the upper part of FIG. 4 indicates a dimension for reference. As illustrated in the schematic view in the lower part of FIG. 4, the laser beam 9 was emitted from the upper part of the drawing. Columnar crystal grains 801 are formed toward the irradiated position of the laser beam 9. Hereinafter, a region where the crystal grains 801 exist in the first terminal 21 is referred to as a first crystal grain region 810, and a region where the crystal grains 801 exist in the second terminal 22 is referred to as a second crystal grain region 820. The first crystal grain region 810 and the second crystal grain region 820 have a structure form specific to a region irradiated with the laser a plurality of times in the thermal conduction mode, and this is because a cooling rate in the melting and solidification process is extremely slow. In general, since crystal grain boundaries obstruct electrical conduction, the crystal grain size is preferably larger, and is preferably 45 μm or more at the joint portion where electrical conduction is limited. The crystal grain size is more preferably 55 μm or more, and still more preferably 65 μm or more.

Hereinafter, regions of the first terminal 21 and the second terminal 22, melted by the laser beam 9, and joined to each other by subsequent cooling is referred to as a welded portion 800. The welded portion 800 includes the first crystal grain region 810 and the second crystal grain region 820.

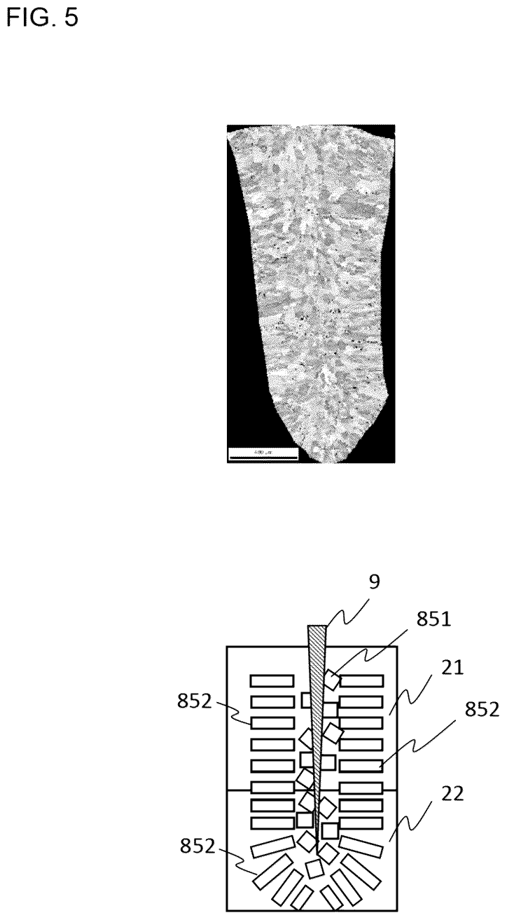

FIG. 5 is a cross-sectional view of a welding position in keyhole mode welding as a comparative example. The upper part of FIG. 5 is a cross-sectional photograph, and the lower part of FIG. 5 is a schematic view for describing the cross-sectional photograph. Also in FIG. 5, the first terminal 21 and the second terminal 22 overlap with each other in the vertical direction in the drawing. Since the keyhole mode welding is performed, the laser beam 9 reached a deep position at the center. In the keyhole mode welding, since the cooling rate is relatively high, the crystal grain size is fine. In addition, in a shape of the crystal, isotropic fine crystal grains called equiaxed crystals 851 are generated at a center of the bead, and a structure is obtained in which columnar crystals 852 extend toward the center of the bead.

### EXAMPLES

Hereinafter, a laser welding method of the present embodiment will be specifically described.

### Example 1

The first terminal having a width of 8 mm and a thickness of 1 mm and the second terminal having a width of 8 mm and a thickness of 1.5 mm were overlapped with each other, and the overlapped portion was subjected to the laser welding. A green laser having a laser wavelength of 532 nm was used, and a condition that the energy density was 1500 kW/cm2 or less was adopted so as to achieve the thermal conduction mode welding. A step of irradiating the second upper surface 22U with the laser after irradiating the first upper surface 21U with the laser was regarded as one time, and two patterns of a pattern in which the step was performed one time and a pattern in which the step was performed ten times were performed.

A laser trajectory is a trajectory along the end surface of the first terminal 21 even in either case of irradiating the first terminal 21 or the second terminal 22. The distance of the laser irradiated position was set to 0.5 mm from the end surface. During the laser welding experiment, the molten pool was photographed by a high-speed camera to confirm the presence of sputtering. A bandpass filter of 950 nm±50 nm was attached to the high-speed camera, and photographing was performed at a frame rate of 500 fps. As a result of the laser welding experiment, the sputtering did not occur in either case of performing the laser irradiation step one time and ten times, but it was confirmed that the first terminal 21 and the second terminal 22 were not joined to each other in the case of only one time, and the first terminal 21 and the second terminal 22 were joined to each other in the case of ten times.

Subsequently, a joined welding sample was cut in a direction perpendicular to the laser scanning direction, and a cross-sectional sample was collected. The collected cross-sectional sample was first polished with water-resistant emery paper #1000. Then, mirror polishing was performed using diamond abrasives of 9 μm, 3 μm, and 1 μm. Further, the upper part of FIG. 4 shows a cross-section obtained by etching the sample with an aqueous solution in which iron chloride is dissolved with hydrochloric acid and ethanol and observing the cross-section with an optical microscope. It can be confirmed from FIG. 4 that the coarse columnar crystal grains 801 extend toward the position irradiated with the laser beam 9.

Subsequently, the cross-sectional sample was mirror-polished, and after strain on the surface was removed using an active oxide burnish suspension, the crystal grain size of the joint portion was measured by an electron backscatter diffraction (EBSD) method. As a result, it was found that the average crystal grain size was 67.2 μm, and the maximum crystal grain size was 312.2 μm. The crystal grain size s a value calculated as an equivalent circle diameter.

### Example 2

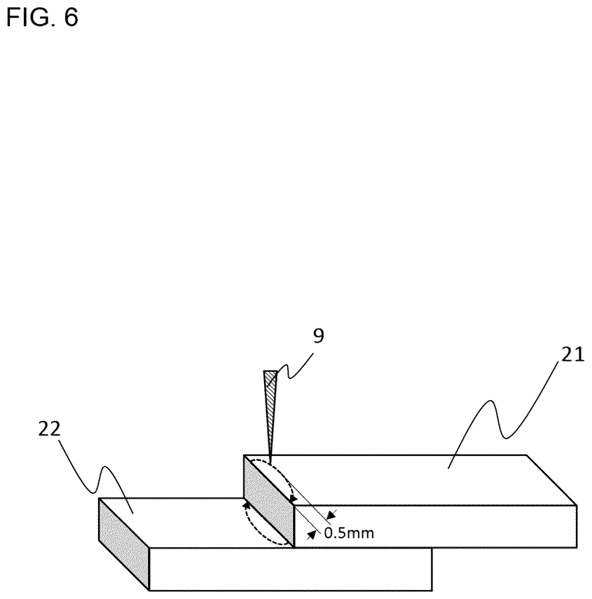

FIG. 6 is a view illustrating irradiation with the laser beam 9 in Example 2. In Example 2, similarly to Example 1, the first terminal 21 and the second terminal 22 were overlapped with each other, and the laser welding was performed by an irradiation method called wobbling while drawing an elliptical trajectory in which the upper surfaces of both the first terminal 21 and the second terminal 22 were irradiated with the laser as indicated by a dotted line in FIG. 6. The wobbling means that the irradiated position is scanned such that the irradiated position with the laser beam moves in a predetermined direction while drawing a circle.

The lengths of the major axis and the minor axis of the ellipse were 7 mm and 1 mm, respectively. Wobbling conditions were a width of 0.8 mm, a pitch of 0.2 mm, and a rotation frequency of 250 Hz. Also in Example 2, a green laser having a laser wavelength of 532 nm was used, and the condition that the energy density was 1500 kW/cm2 or less was adopted so as to achieve the thermal conduction mode welding. A step of making one round of the elliptic trajectory was regarded as one time, the step was performed one time, five times, and eight times. When the step was performed five times and eight times, the laser irradiation was continuously performed without stopping the laser irradiation every one cycle. As a result, the sputtering did not occur in either case, but joining was not performed when the laser irradiation was performed only one time. When the laser irradiation was performed five times, a part was joined, but an unjoined portion was confirmed. On C the other hand, when the laser irradiation was performed eight times, it has been confirmed that there is no unjoined portion and the joining is performed.

Subsequently, the sample subjected to the laser irradiation eight times was cut in a direction perpendicular to the laser scanning direction, and a cross-sectional sample was collected. The cross-sectional sample was polished using the water-resistant emery paper #1000 and mirror polished using the diamond abrasives of 9 μm, 3 μm, and 1 μm. Further, after strain on the surface of the sample was removed using the active oxide burnish suspension, the crystal grain size of the joint portion was measured by the EBSD method. As a result, it was found that the average crystal grain size was 55.7 μm, and the maximum crystal grain size was 198.7 μm.

### Comparative Example 1

The first terminal 21 and the second terminal 22 having the same dimensions as those of Example 1 were overlapped with each other, and fillet welding was performed on the overlapped portion under the condition of the keyhole welding, for example, under the condition of an energy density of 1500 kW/cm2 or more. As the laser, a green laser having the same wavelength of 532 nm as in Example 1 was used, and the number of times of welding was set to one time. As a result, it was confirmed that joining was performed by only one welding, but a large amount of sputtering was generated. Subsequently, the joined welding sample was cut in a direction perpendicular to the laser scanning direction, a cross-sectional sample was collected, and then the crystal grain size of the joint portion was measured by mirror polishing and the EBSD method in the same manner as in Example 1. As a result, it was found that the average crystal grain size was 30.1 μm, and the maximum crystal grain size was 92.8 μm.

### Comparative Example 2

The first terminal 21 and the second terminal 22 having the same dimensions as those of Example 1 were overlapped with each other and lap welding was performed under the condition of the keyhole welding. An IR laser having a laser wavelength of 1064 nm was used, and welding was performed two times on the same trajectory. As a result, it was confirmed that the first terminal 21 and the second terminal 22 were joined to each other, but a large amount of sputtering was generated as in Comparative Example 1. Subsequently, the joined welding sample was cut in a direction perpendicular to the laser scanning direction, a cross-sectional sample was collected, and then the crystal grain size of the joint portion was measured by mirror polishing and the EBSD method in the same manner as in Example 1. As a result, it was found that the average crystal grain size was 24.4 μm, and the maximum crystal grain size was 101.4 μm.

### Comparative Example 3

The first terminal 21 and the second terminal 22 having the same dimensions as those of Example 1 were overlapped with each other and lap welding was performed under the condition of the keyhole welding. The wobbling welding was performed using an IR laser having a laser wavelength of 1064 nm. As a result, it was confirmed that the first terminal 21 and the second terminal 22 were joined to each other, and the sputtering was suppressed as compared with Comparative Example 1 and Comparative Example 2, but the sputtering occurred. Subsequently, the joined welding sample was cut in a direction perpendicular to the laser scanning direction, a cross-sectional sample was collected, and then the crystal grain size of the joint portion was measured by mirror polishing and the EBSD method in the same manner as in Example 1. As a result, it was found that the average crystal grain size was 42.2 μm, and the maximum crystal grain size was 159.2 μm.

According to the above-described embodiment, the following operational effects can be obtained.
(1) In the laser welding method used in the power conversion device 1, the first terminal 21 and the second terminal 22 made of a metal material containing copper or aluminum as a main component are overlapped with each other, and the overlapped region is melt-joined by the laser. This laser welding method includes a laser irradiation step of irradiating each of the first upper surface 21U that is an opposite surface to a surface of the first terminal 21 overlapped with the second terminal 22 and the second upper surface 22U that is a surface on the same side as the surface of the second terminal 22 overlapped with the first terminal 21 with laser along the edge of the first terminal 21. In the laser irradiation step, the laser irradiation is performed a plurality of times under the condition of the thermal conduction mode welding. Thus, the occurrence of the sputtering due to welding can be suppressed.
(2) A welded portion forming step is included in which by solidifying the overlapped region melted in the laser irradiation step, the welded portion 800 having an average crystal grain size of 50 μm or more is formed. Thus, an electrical conductivity of the welded portion 800 can be improved. Details are as follows. In general, in metal materials, the crystal grain boundaries obstruct electrical conduction. In the welding method according to the present embodiment, by performing laser irradiation a plurality of times in the thermal conduction mode, the crystal grains of the joint portion become coarse crystal grains that grow toward a laser irradiated point as illustrated in FIG. 4. This reduces a crystal grain boundary density and improves the electrical conductivity. In addition, since the electrical conductivity is improved, heat generation and energy loss can be suppressed.
(3) The power conversion device 1 includes the terminal joint structure including the welded portion 800 in which the first terminal 21 and the second terminal 22 made of a metal material containing copper or aluminum as a main component are overlapped with each other, and the first terminal 21 and the second terminal 22 are melt-joined by the laser. The welded portion 800 includes the first crystal grain region 810 in which columnar crystal grains extend toward the region along the edge of the first terminal 21 on the first upper surface 21U that is an opposite surface to the overlapped surface between the first terminal 21 and the second terminal 22, and the second crystal grain region 820 in which columnar crystal grains extend toward the region along the edge of the first terminal 21 on the second upper surface 22U that is a surface on the same side as the overlapped surface. According to this joint structure, since the crystal grains are likely to be coarsened, the crystal grain boundary density is reduced and the electrical conductivity is improved.
(4) In the terminal joint structure included in the power conversion device 1, the average crystal grain size in the welded portion 800 is 50 μm or more. Thus, the welded portion 800 having good electrical conductivity can be obtained.
(5) The power conversion device 1 has the above-described terminal joint structure. Thus, the power conversion device 1 having good electrical conductivity can be obtained.

### Modification 1

In the above-described embodiment, the laser beam 9 is emitted along the edge of the first terminal 21 on the X-axis direction minus side. However, a through hole may be provided in the first terminal 21, and the laser beam 9 may be emitted along an edge of the through hole.

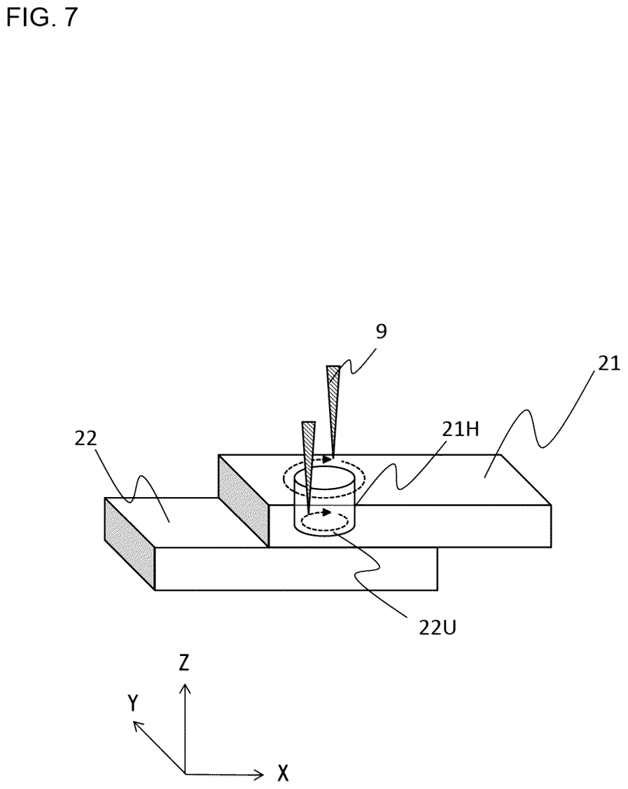

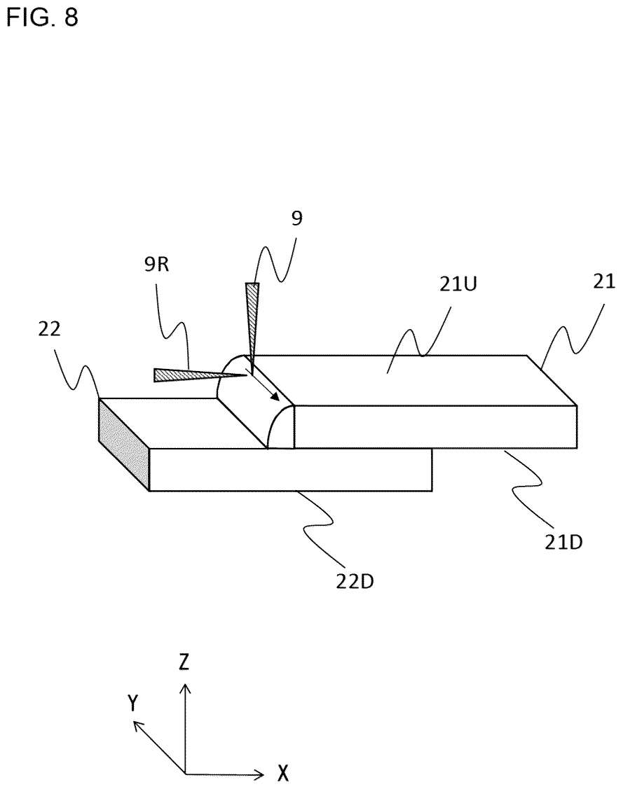

FIG. 7 is a view illustrating a welding method in Modification 1. The first terminal 21 is provided with a through hole 21H, and the second upper surface 22U is exposed on the Z-axis plus side through the through hole 21H. In the present modification, the edge of the through hole 21H in the first upper surface 21U and the second upper surface 22U is irradiated with the laser beam 9. A positional relationship between a position irradiated with the laser beam 9 and the edge is the same as that of the above-described embodiment. The present modification has an effect of suppressing an adverse influence caused by reflection of the laser beam 9. This effect will be described with reference to FIG. 8.

FIG. 8 is a view for describing an effect of Modification 1. When the first terminal 21 is irradiated with the laser a plurality of times along the end surface, there is a possibility that laser reflection 9R occurs on the end surface in a case where the end surface is melted and the shape is changed as illustrated in FIG. 8, or in a case where the spot diameter is increased by defocusing the laser and a part thereof protrudes from the end surface. When the laser reflection 9R occurs, surrounding members, for example, modules and circuits may be damaged. Thus, as illustrated in FIG. 7, by providing the through hole 21H in the first terminal 21 and emitting the laser beam 9 along the edge of the through hole 21H, the laser reflection 9R remains inside the through hole 21H even when the laser reflection 9R occurs. Thus, the influence of the laser reflection 9R can be suppressed, and damage to the surroundings can also be reduced.

### Example 3

As illustrated in FIG. 7, the first terminal 21 was provided with the through hole 21H and overlapped with the second terminal 22, and each of the first upper surface 21U and the second upper surface 22U were irradiated with the laser along the edge of the through hole 21H. The dimensions of the first terminal 21 and the second terminal 22, the wavelength of the laser beam 9, and the emission conditions of the laser beam 9 were the same as those in Example 1 described above, and the laser irradiated position was set to a position 0.5 mm from the edge. The step of irradiating the first upper surface 21U and the second upper surface 22U with the laser beam 9 was regarded as one time, and two patterns of a case where the step was performed only one time and a case where the step was performed eight times were performed. As a result, it was confirmed that the sputtering did not occur in both cases, but the first terminal 21 and the second terminal 22 were not joined to each other in the case where the laser irradiation step was performed only one time, and the first terminal 21 and the second terminal 22 were joined to each other in the case where the laser irradiation step was performed eight times.

Subsequently, the joined welding sample was cut in a direction perpendicular to the laser scanning direction, a cross-sectional sample was collected, and then the crystal grain size of the joint portion was measured by mirror polishing and the EBSD method in the same manner as in Example 1. As a result, it was found that the average crystal grain size was 88.7 μm, and the maximum crystal grain size was 415.4 μm.

According to Modification 1, the following operational effects can be obtained.
(6) The edge of the first terminal 21 is the edge of the through hole 21H provided in the first terminal 21. In the laser irradiation step, each of the first upper surface 21U and the second upper surface 22U is irradiated with the laser along the edge of the through hole 21H, and the welded portion 800 is formed along the edge of the through hole 21H. Thus, the influence of the laser reflection 9R as illustrated in FIG. 8 can be suppressed, and the damage to the surroundings can also be reduced.

### Modification 2

In the above-described embodiment, the first terminal 21 has a flat plate shape, but the first terminal 21 may be processed so that the temperature easily rises by irradiation with the laser beam 9. For example, heat capacity of the region irradiated with the laser beam 9 in the first terminal 21 may be reduced, or a movement path of heat may be reduced so that heat is less likely to move to a region not irradiated with the laser beam 9.

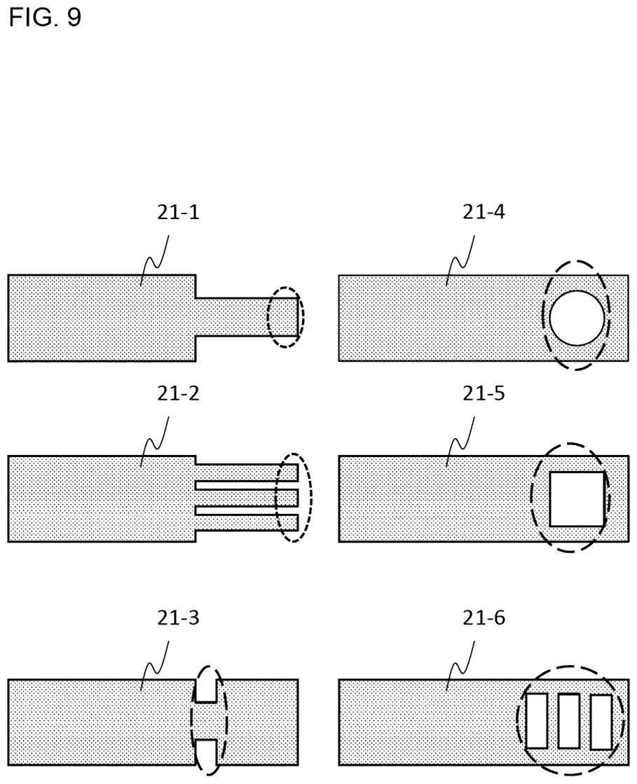

FIG. 9 is a view illustrating shapes of a first terminal 21 in Modification 2. In FIG. 9, six examples from a reference numeral “21-1” to a reference numeral “21-6” are illustrated.

is In any of the examples, the right side in the drawing irradiated with the laser beam 9. The first terminal 21 denoted by each of the reference numerals “21-1” and “21-2” has reduced heat capacity in a range indicated by the dotted line and irradiated with the laser beam 9. In the first terminal 21 denoted by each of the reference numerals “21-3” to “21-6”, the area of the region irradiated with the laser beam 9 is the same as that in the embodiment, but the movement path of heat is reduced so that the heat is less likely to move to the region not irradiated with the laser beam 9 in the region surrounded by the broken line. In any of the reference numerals “21-1” to “21-6”, the region surrounded by the broken line is a low heat capacity region having a relatively smaller heat capacity than other regions.

According to Modification 2, the following operational effects can be obtained.
(7) In the first terminal 21, a low heat capacity region having a heat capacity relatively smaller than that of a region not overlapping the second terminal 22 is provided on a distal end side overlapping the second terminal 22. Thus, since the laser welding can be performed with a small amount of heat input, there are an advantage that welding becomes easy and an advantage that damage to the surrounding members due to heat can be reduced.

The above-described embodiments and modifications may be combined. Although various embodiments and modifications have been described above, the present invention is not limited to these contents. Other aspects conceivable within the scope of the technical idea of the present invention are also included within the scope of the present invention.

### REFERENCE SIGNS LIST

1 power conversion device
2 semiconductor element
2A connection terminal
9 laser beam
10 laser
21 first terminal
21H through hole
21U first upper surface
22 second terminal
22U second upper surface
800 welded portion
801 crystal grain
810 first crystal grain region
820 second crystal grain region

1.-9. (canceled)

10. A laser welding method of overlapping a first terminal and a second terminal made of a metal material containing copper or aluminum as a main component with each other, and melt joining the first terminal and the second terminal by laser, the laser welding method comprising:
a laser irradiation step of irradiating each of a first upper surface that is an opposite surface to a surface of the first terminal overlapped with the second terminal and a second upper surface that is a surface on the same side as a surface of the second terminal overlapped with the first terminal with the laser along an edge of the first terminal,
wherein in the laser irradiation step, the laser irradiation is performed a plurality of times under a condition of thermal conduction mode welding.

11. The laser welding method according to claim 10,
wherein the edge of the first terminal is an edge of a through hole provided in the first terminal, and
in the laser irradiation step, each of an upper surface of the first terminal and an upper surface of the second terminal is irradiated with the laser along the edge of the through hole.

12. The laser welding method according to claim 10, wherein the first terminal is provided with a low heat capacity region having a heat capacity relatively smaller than a heat capacity of a region not overlapping the second terminal on a distal end side overlapping the second terminal.

13. The laser welding method according to claim 10, further comprising forming a welded portion by solidifying the overlapped portion melted in the laser irradiation step to form the welded portion having an average crystal grain size of 50 μm or more.

14. A terminal joint structure comprising:
a welded portion in which a first terminal and a second terminal made of a metal material containing copper or aluminum as a main component are overlapped with each other and an overlapped portion is melt-joined by laser,
wherein the welded portion includes a first region in which columnar crystal grains extend toward a region along an edge of the first terminal on an upper surface of the first terminal that is an opposite surface to an overlapped surface between the first terminal and the second terminal, and a second region in which columnar crystal grains extend toward a region along the edge of the first terminal on an upper surface of the second terminal that is a surface on the same side as the overlapped surface.

15. The terminal joint structure according to claim 14, wherein an average crystal grain size in the welded portion is 50 μm or more.

16. The terminal joint structure according to claim 14,
wherein the edge of the first terminal is an edge of a through hole provided in the first terminal, and
the welded portion is formed along the edge of the through hole.

17. The terminal joint structure according to claim 14, wherein the first terminal is provided with a low heat capacity region having a heat capacity relatively smaller than a heat capacity of a region not overlapping the second terminal on a distal end side overlapping the second terminal.

18. A power conversion device comprising:
the terminal joint structure according to claim 14.
